(19) United States
(12) Patent Application Publication
(10) Pub. No.: US 2005/0030375 A1
(43) Pub. Date: Feb. 10, 2005

(54) Image capture device with multiple protocol wireless transmission

(76) Inventors: Giovanni Zangrande, Ft. Lauderdale, FL (US); Joseph Flynn, Ft. Lauderdale, FL (US)

Correspondence Address: CONCORD CAMERA CORP., 4000 HOLLYWOOD BLVD, #650N, HOLLYWOOD, FL, 33021, US

(21) Appl. No.: 10/494,696

(22) PCT Filed: Nov. 7, 2002
(86) PCT No.: PCT/US02/35818

Related U.S. Application Data
(60) Provisional application No. 60/345,067, filed on Nov. 9, 2001.

(51) Int. Cl. H04N 7/18

(52) U.S. Cl. 348/143

(57) ABSTRACT

An image capture device is provided which is able to wirelessly communicate with external devices using multiple communications protocols. At least one image is acquired and stored by the image capture device. The image capture device than negotiates with the external device to establish basic communications parameters and attempts to communicate with the external device in a first communications protocol. If unsuccessful, the image capture device attempts to communicate with the external device in at least a second communications protocol. If successful, the image is transferred to the external device. If unsuccessful, the image capture device may, optionally, attempt to communicate with the external device in additional different communication protocols. The present image capture device can communicate with a wide variety of device types presently understanding different transmission protocols.

### PRIORITY

The present application claims priority from co-pending provisional patent application Ser. No. 60/345,067, Filed on Nov. 9, 2001 and entitled IMAGE CAPTURE DEVICE WITH MULTIPLE PROTOCOL WIRELESS TRANSMISSION.

### FIELD OF THE INVENTION

The present invention relates to the field of image capture devices such as cameras and image scanners and, more particularly, for an image capture device that communicates with other devices using any of a number of multiple wireless communication protocols.

### BACKGROUND OF THE INVENTION

Recently, a wide variety of wireless protocols have been advanced to communicate between new technological devices in the interest of establishing a “wireless office”. Even the so-called standards, such as IrDA, include multiple protocols for addressing different types of devices. For example, under IrDA, the IrTran-P protocol jointly defined by Casio, Okaya Systemware, NTT, Sharp and Sony specifically targets image transfer applications, such as communications between an image capture device (i.e., a digital camera) and a photoprinter or personal computer (“PC”). Whereas, the IrDA standard IrMC protocol established by a group including Ericsson, Motorola, Nokia, NTT DoCoMo, and Puma, targets information transfer to mobile communications devices such as, mobile phones, notebooks PCs, personal digital assistants (“PDAs”), pagers and even wristwatches. Due to this communication gap, many devices cannot communicate with each other, or universally with all of the devices being produced.

What is needed is an image capture device that can communicate universally with a plurality of devices, each having a different communication protocol. What is further needed is an image capture device that can negotiate with devices of different protocols and determine which protocol is required to communicate with a particular device.

These and other objects and advantages of the present invention will become more readily apparent in the description that follows.

### SUMMARY OF THE INVENTION

An image capture device is provided which is able to wirelessly communicate with external devices using multiple communications protocols. At least one image is acquired by the image capture device. The image capture device negotiates with the external device to establish basic communications parameters and attempts to communicate with the external device in a first communications protocol. If unsuccessful, the image capture device attempts to communicate with the external device in at least a second communications protocol. If successful, the image is transferred to the external device. In one particular embodiment, if the image transfer is unsuccessful, the image capture device attempts to communicate with the external device in yet a third communications protocol. This process may continue until the image capture device identifies the particular communication protocol applicable to the external device and uses such protocol to transfer the image.

These and other objects and advantages of the present invention will become more readily apparent in the description that follows.

### BRIEF DESCRIPTION OF THE DRAWINGS

The foregoing summary, as well as the following detailed description of the preferred embodiments, is better understood when read in conjunction with the appended drawings. For the purpose of illustrating the invention, there is shown in the drawings an exemplary embodiment that is presently preferred, it being understood, however, that the invention is not limited to the specific methods and instrumentality's disclosed. Additionally, like reference numerals represent like items throughout the drawings. In the drawings:

FIG. 1 is a block diagram of an image capture system in accordance with one embodiment of the present invention.

FIG. 2 is a block diagram of one specific implementation of the present invention.

FIG. 3 is a diagram showing the interaction of certain exemplary devices useful with the present invention.

FIG. 4 is a flow diagram of one embodiment of the present invention.

FIG. 5 is a flow diagram of another aspect of one particular implementation of the present invention.

FIG. 6 is a block diagram of one particular image capture device useful with the present invention.

### DETAILED DESCRIPTION OF THE PREFERRED EMBODIMENTS

Before explaining the disclosed embodiments of the present invention in detail, it is to be understood that the invention is not limited in its application to the details of the particular arrangement shown since the invention is capable of other embodiments. Also, the terminology used herein is for the purpose of description and not of limitation.

The present invention relates to the wireless transmission of data from an image capture device. In the present embodiments, the image capture device acquires an image and wirelessly transmits the image to another device. In transmitting the image, the image capture device negotiates with the receiving device and is capable of providing the data to the receiving device in a plurality of wireless protocols so as to universally communicate with a wide variety of device types presently understanding different transmission protocols.

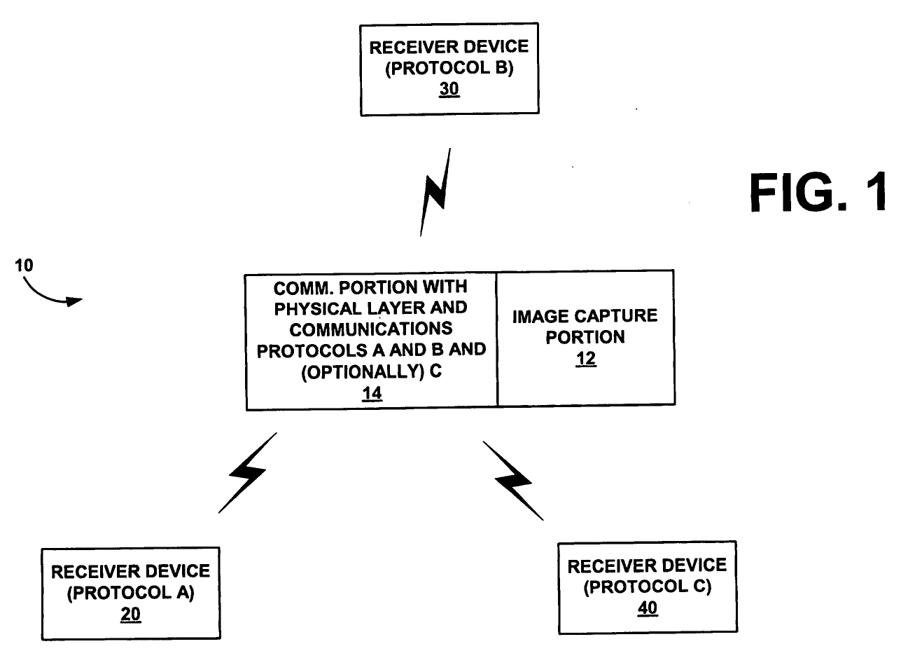

Referring now to FIG. 1, there is shown a block diagram of one embodiment of the present invention. An image capture device 10 includes an image capture portion 12, for receiving an image, and a communications portion 14 for wirelessly communicating the captured image to one or more of a variety of external devices (i.e. 20, 30, 40). The communications portion 14 includes at least two different communications protocols for communicating with the external devices.

As shown in FIG. 1, an image capture device 10 is pre-programmed with different protocols A and B for communicating with receiver device 20 (which only communicates in protocol A) and receiver device 30 (which only communicates in protocol B). Optionally, the image capture device 10 may include other protocols, such as protocol C, to communicate with additional devices (such as receiver device 40) and improve the universality of the wireless image capture device 10.

The communications protocols may be stored in the image capture device 10 in EEPROM as firmware, may be burnt into ROM or may be read into RAM upon insertion of a cartridge into a memory slot of the image capture device 10. However, this is not meant to be limiting, the communications protocols may be stored in the image capture device in any other known way.

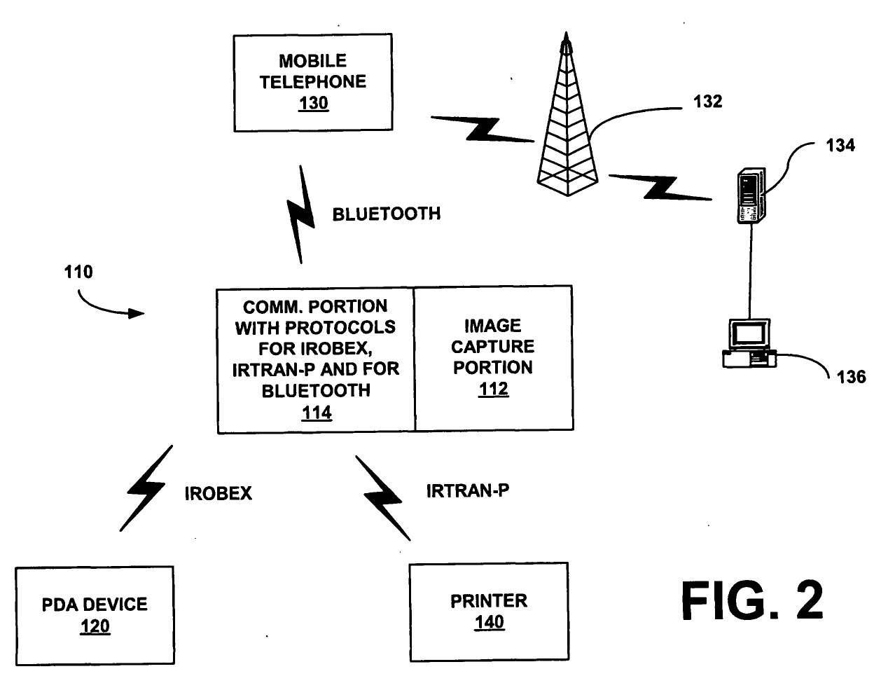

Referring now to FIG. 2, there is shown a block diagram of one specific implementation of the present invention. A wireless image capture device 110 includes a image capture portion 112, such as a digital camera including an object lens, image processor and storage (not shown). The wireless image capture device 110 additionally includes a communications portion 114 programmed with a plurality of communications protocols. In the present implementation the communications portion is programmed with two IrDA standard communications protocols, IrTran-P and IrOBEX.

Additionally, the image capture device 110 may be programmed to communicate in accordance with the BLUETOOTH communications specification. However, this is not meant to be limiting. If desired, the wireless image capture device may communicate in both the IrOBEX and the BLUETOOTH protocols, but not IrTran-P. This implementation would be cost effective storagewise, as both IrOBEX and BLUETOOTH can be implemented using the same underlying OBEX libraries. Alternatively, IrTran-P and BLUETOOTH or IrTran-P and IrObex may be implemented in the wireless image capture device, so long as the image capture device 110 is programmed to communicate in at least two different wireless communications protocols. Further, other communications protocols such as Wireless Application Protocol (WAP) and/or Mobile Media Mode (MMM) may be used instead of and/or in addition to the other protocols described herein.

Additionally, the communications portion 114 includes any physical hardware required to communicate in accordance with the included protocols. For example, for communication in accordance with one or more protocols of the IrDA specifications, the wireless image capture device 110 may include an IrDA transceiver chip, such as the HSDL-3202, HDSL 3210 or HDSL 3310, all by AGILENT TECHNOLOGIES. If the image capture device communicates in accordance with the BLUETOOTH specification, a BLUETOOTH transceiver, such as the NATIONAL SEMICONDUCTOR CP3BT17 BLUETOOTH Module, would be included.

Referring back to FIG. 2, the wireless device 110 is programmed to be able to communicate wirelessly using multiple different communications protocols to communicate with multiple devices. For example, a PALM PDA device 120 includes an Ir communication port programmed in accordance with the IrObex IrDA specification. Many photoprinters 140 include an Ir port and are programmed in accordance with the IrTran-P specification. The image capture device 110 can communicate with whichever device is aligned with its Ir port. Alternatively, if no device is detected as being aligned with the Ir port, the wireless image capture device may attempt to establish communications with a BLUETOOTH device (such as the mobile telephone 130), using the BLUETOOTH protocol. Mobile telephone 130 may be a mobile telephone, such as the T681 by ERICSSON, which includes BLUETOOTH functionality. Alternatively, a mobile telephone may be used which communicates via the IrDA specifications, such as the 9210 Communicator by NOKIA.

Further, the images acquired and transferred to the mobile telephone 130 may be further wirelessly transferred via the cellular network 132 (or by some other type of network, i.e. land lines, metricom radio network, satellite, etc.) to a server 134, such as that hosted by LIGHTSURF. Computer users having access to the internet via a PC 136 can then view the images wirelessly posted in real-time by friends and family.

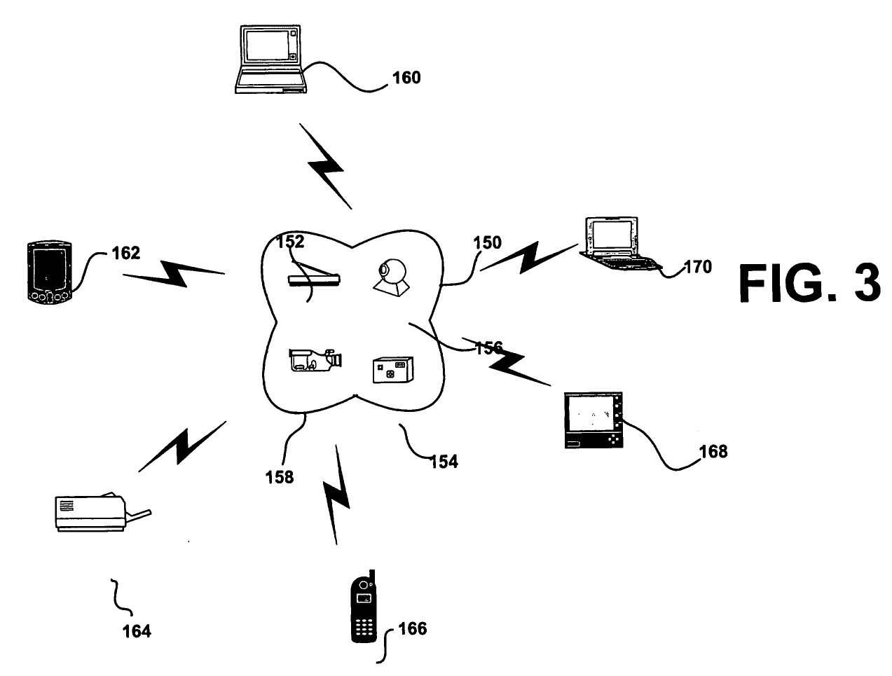

Referring now to FIG. 3, there is shown a diagram of the interaction of certain exemplary devices useful with the present invention. Group 150 represents a sampling of the possible image capture devices useful with the present invention. It can be seen from the foregoing how incorporation of multiple different communication protocols in such devices as wireless scanner 152, digital still camera 154, webcam 156 and video camera 158 permits each of those devices to communicate with a whole host of other devices programmed in accordance with a variety of different communications protocols. Such devices that regularly communicate using wireless communication protocols include laptop 160, handheld PDAs and pocket PCs 162, photoprinters 164, mobile telephones 166, handheld toys/gaming devices 168 (such as the GAMEBOY COLOR by NINTENDO) and handheld PCs 170.

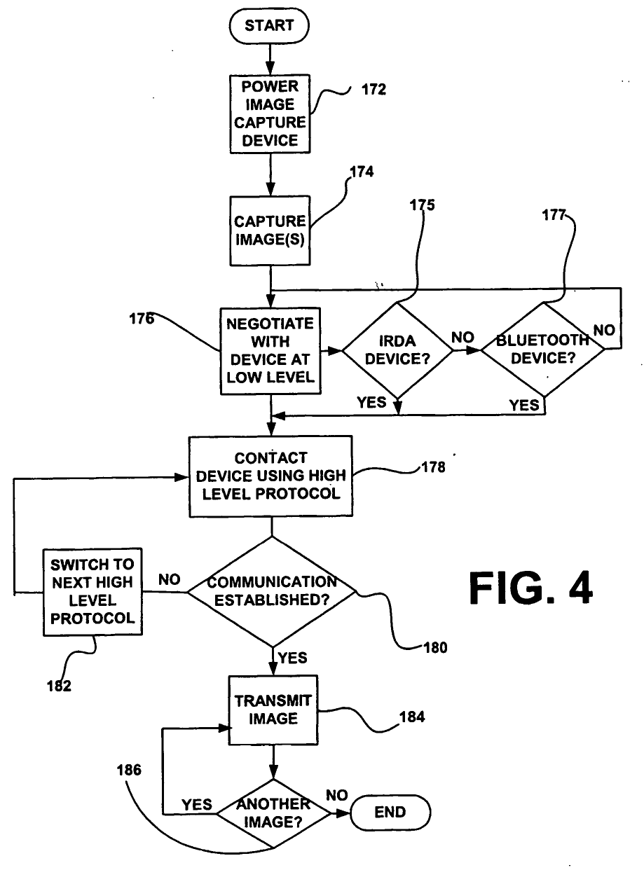

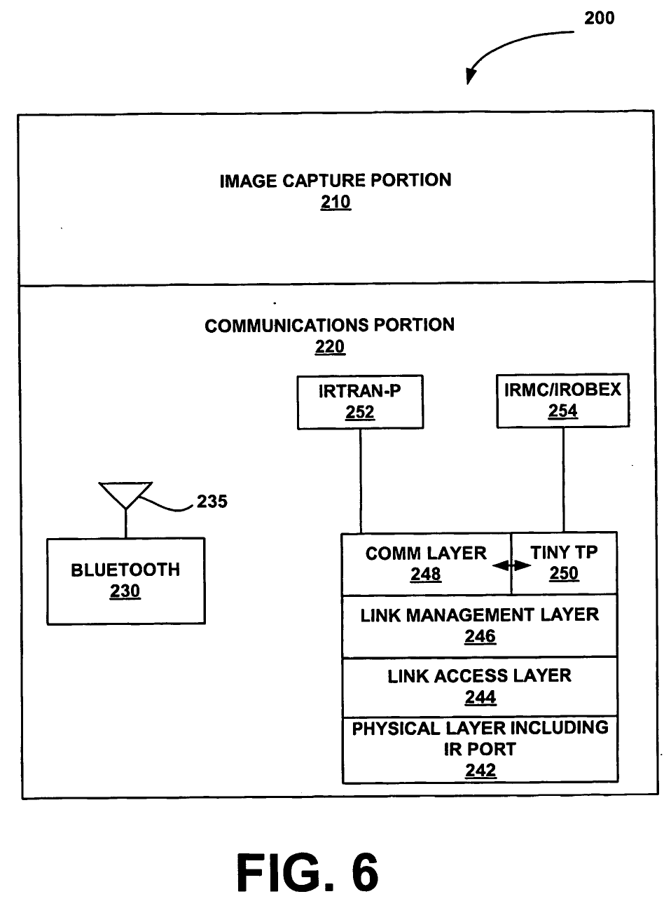

Referring now to FIGS. 4 and 6, there are shown flow diagrams and an image capture device in accordance with one specific implementation of the present invention. Image capture device 200 includes an image capture portion 210, examples of which are given above. Additionally, in the present embodiment, the image capture device 200 is enabled to communicate in the IrDA standard IrTran-P and IrObex protocols, as well as the BLUETOOTH protocol. However, this is not meant to be limiting as the image capture device can be programmed to accommodate as few as two different communications protocols, or as many greater than two as is determined to be useful. To communicate with both IrDA protocol devices and with the BLUETOOTH device, the wireless image capture device includes a BLUETOOTH transceiver 230 with its accompanying antenna 235. Additionally, the communications portion 220 includes an assembly in accordance with the IrDA specifications. A physical layer 242 includes an Ir transceiver and other physical components to provide an interface for the point-to-point communication between the image capture device 200 and the external receiving device. The Link Access Layer (IrLAP) 244 provides guidelines for the software that looks for other machines to connect to (sniff), discovers other machines (discover), resolves addressing conflicts, initiates a connection, transfers data and cleanly disconnects. The IrLAP layer 244 specifies the frame and byte structure of Ir packets, as well as the error detection methodology for Ir communications. The Link Management layer (IrLMP) 246 sits above the IrLAP and provides services to both the Transport layer and directly to the application layer. The communications layer (IrComm) 248 allows existing communication applications that talk to other devices via serial and parallel ports to work over Ir without any changes in their code. The IrTran-P protocol 252 works with the IrComm layer 248. The tiny transport layer or Tiny TP 250 is used by the IrObex protocol to communicate.

Referring back to FIG. 4, the wireless image capture device 200 is powered on. Step 172. The device is used to capture or acquire an image or images. Step 174. If the user selects the wireless transmission option on the image capture device, the image capture device proceeds to negotiate with the external receiving device (20, 30 or 40 of FIG. 1; 120, 130 or 140 of FIG. 2). Step 176. The image capture device first attempts to negotiate with the external receiving device using the low level general communication language that is part of the IrDA standard. This occurs at the IrLAP layer 244. If general communication is established (thus confirming that the external receiving device is an IrDA capable device), the wireless image capture device than attempts to contact the external receiving device using the first of its two pre-programmed IrDA protocols. IrTran-P, for example. If, after trying to communicate using IrTran-P a preselected number of times, no communication is established, the wireless image capture device 200 knows to try the next IrDA high level language. IrObex, for example. Steps 180 and 182. If communication is established, the image(s) is/are transmitted to the wireless external receiving device. Steps 180, 184 and 186.

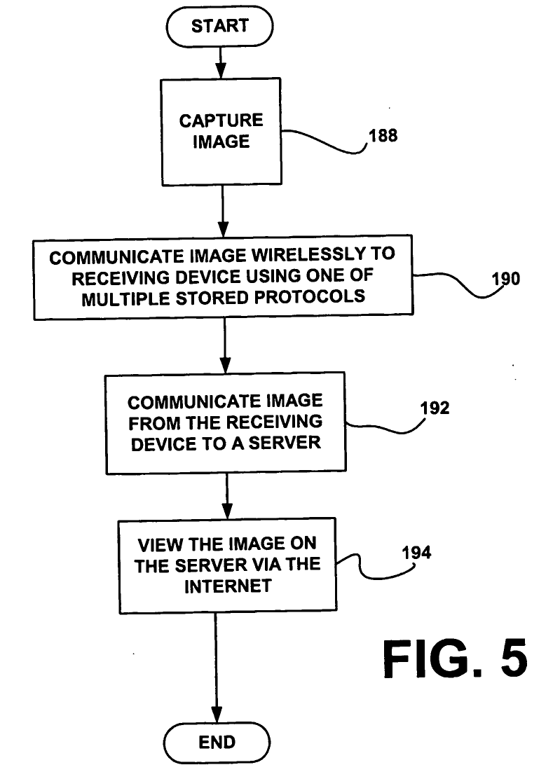

Referring now to FIG. 5, there is shown a flow diagram of another aspect of one particular implementation of the present invention. The image capture device captures an image or images. Step 188. The images are wirelessly transmitted using one of the multiple stored communication protocols to the external receiving device. Step 190. The receiving device than communicates the received image(s) to a server. Step 192. The user and/or users family or customers (insurance company, real estate listings, etc.) is able to view the uploaded stored images from the server via the internet in real time. Step 194.

While the invention has been described with reference to certain embodiments, it will be understood by those skilled in the art that various changes may be made and equivalents may be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An image capture communication system for capturing and communicating an image to at least one image receiving device, comprising:
an image capture device including:
an image capture portion for acquiring at least one image;
a communications portion for receiving said image from said image capture portion, said communications portion including at least one wireless communication transmitter for wirelessly communicating said image in a first wireless protocol and in a second wireless protocol different from said first wireless protocol;
wherein said communications portion first attempts to communicate wirelessly with the at least one image receiving device in said first wireless protocol, and wherein if said first attempt is unsuccessful, said communications portion attempts to communicate wirelessly with the at least one image receiving device using said second wireless protocol.

2. The image capture communication system of claim 1, wherein said image capture device is chosen from the group including a digital still camera, a webcam, a wireless scanner and a video camera.

3. The image capture communication system of claim 2, wherein said at least one wireless communication transmitter includes a BLUETOOTH transmitter;

4. The image capture communication system of claim 1, wherein said at least one wireless communication transmitter includes an Ir transmitter;

5. The image capture communication system of claim 4, wherein said Ir transmitter transmits using both said first wireless protocol and said second wireless protocol.

6. The image capture communication system of claim 5, wherein said first wireless protocol and said second wireless protocol include the IrTran-P and IrOBEX protocols.

7. The image capture communication system of claim 4, wherein said communications portion additionally includes a second wireless communication transmitter.

8. The image capture communications system of claim 7, wherein said second wireless communication transmitter is a BLUETOOTH transmitter.

9. The image capture communication system of claim 8, wherein said Ir transmitter transmits both in said first wireless protocol and in said second wireless protocol and wherein said BLUETOOTH transmitter attempts to transmit to said at least one receiving device using the BLUETOOTH communications protocol if both said first attempt and said second attempt fail.

10. The image capture communication system of claim 9, wherein said first wireless protocol and said second wireless protocol include the IrTran-P and IrOBEX protocols.

11. The image capture communication system of claim 2, wherein said at least one receiving device is chosen from the group including a PC, a PDA, a pocket PC, a printer, a mobile telephone, a gaming device.

12. A method for wirelessly transmitting a captured image to a receiving device, comprising the steps of:
(a) providing an image capture device including an image capture portion and a wireless communications portion programmed with at least first and second different image transfer protocols for communicating a captured image to a receiving device;
(b) capturing an image with said image capture portion;
(c) attempting to contact said receiving device using said first image transfer protocol;
(d) attempting to contact said receiving device using said second image transfer protocol, if communication is not established in (d);
(e) transferring said image to the image receiving device in one of said first and said second image transfer protocol if communication is established in one of (c) and (d).

13. The method of claim 12, additionally comprising the step of:
(f) attempting to communicate with said receiving device using a low level general communication language prior to steps (c) and (d).

14. The method of claim 13, wherein said first image transfer protocol is one of IrTran-P and IrOBEX.

15. The method of claim 14, wherein said second image transfer protocol uses BLUETOOTH.

16. The method of claim 15, wherein said second image transfer protocol is one of IrTran-P and IrOBEX and is different from said first image transfer protocol.

17. The method of claim 12, including the step:
(g) attempting to contact said receiving device using a third image transfer protocol programmed into said wireless communications portion if communication fails in steps (c) and (d).

18. The method of claim 17, wherein said third image transfer protocol uses the BLUETOOTH standard.

19. A digital camera, comprising:
an image capture portion for acquiring and storing at least one image;
a communications portion for receiving said image from said image capture portion, said communications portion including an Ir communication transmitter for wirelessly communicating said image in a first infrared wireless protocol and in a second infrared wireless protocol different from said first wireless protocol;
a user interface to permit a user to select the wireless transmission option to initiate a wireless image transfer operation;
wherein said communications portion is programmed to first attempt to communicate wirelessly with the at least one image receiving device in said first infrared wireless protocol upon an instruction from said user interface, and
wherein if said first attempt is unsuccessful, said communications portion attempts to communicate wirelessly with the at least one image receiving device using said second infrared wireless protocol.

20. The digital camera of claim 19, said at least one image receiving device is chosen from the group including a PC, a PDA, a pocket PC, a printer, a mobile telephone, a gaming device.
